(19) United States
(12) Patent Application Publication
(10) Pub. No.: US 2025/0287944 A1
(43) Pub. Date: Sep. 18, 2025

(54) AMINOETHOXYVINYLGLYCINE AND 1-AMINO-1-CYCLOPROPANECARBOXYLIC ACID AND USES THEREOF

(71) Applicant: Valent BioSciences LLC, Libertyville, IL (US)

(72) Inventors: Steve McArtney, Highland Park, IL (US); Schalk Reynolds, Grayslake, IL (US); Peter D. Petracek, Grayslake, IL (US)

(21) Appl. No.: 19/080,145

(22) Filed: Mar. 14, 2025

Related U.S. Application Data
(60) Provisional application No. 63/566,205, filed on Mar. 15, 2024.

(51) Int. Cl. A01N 37/44; A01P 21/00

(52) U.S. Cl. CPC A01N 37/44; A01P 21/00

(57) ABSTRACT

The present invention is directed to an agricultural mixture comprising aminoethoxyvinylglycine or a salt thereof and 1-amino-1-cyclopropanecarboxylic acid, a hydrate thereof, a polymorph thereof or a salt thereof. The present invention is further directed to methods of enhancing apple characteristics including, but not limited to, color, size, texture and firmness comprising applying an effective amount of aminoethoxyvinylglycine or a salt thereof and an effective amount of 1-amino-1-cyclopropanecarboxylic acid, a hydrate thereof, a polymorph thereof or a salt thereof to apples. The present invention is further directed to methods of reducing fruit drop in an apple tree comprising applying an effective amount of aminoethoxyvinylglycine or a salt thereof and an effective amount of 1-amino-1-cyclopropanecarboxylic acid, a hydrate thereof, a polymorph thereof or a salt thereof to the apple tree.

### FIELD OF THE INVENTION

The present invention is directed to an agricultural mixture comprising aminoethoxyvinylglycine or a salt thereof and 1-amino-1-cyclopropanecarboxylic acid, a hydrate thereof, a polymorph thereof or a salt thereof. The present invention is further directed to methods of enhancing apple characteristics including, but not limited to, color, size, texture and firmness comprising applying an effective amount of aminoethoxyvinylglycine or a salt thereof and an effective amount of 1-amino-1-cyclopropanecarboxylic acid, a hydrate thereof, a polymorph thereof or a salt thereof to apples. The present invention is further directed to methods of reducing fruit drop in an apple tree comprising applying an effective amount of aminoethoxyvinylglycine or a salt thereof and an effective amount of 1-amino-1-cyclopropanecarboxylic acid, a hydrate thereof, a polymorph thereof or a salt thereof to the apple tree.

### BACKGROUND OF THE INVENTION

Aminoethoxyvinylglycine (“AVG”; also known as ([S]-trans-2-amino-4-(2-aminoethoxy)-3-butenoic acid and aviglycine) is a known ethylene antagonist. AVG formulations (such as those available from Valent BioSciences LLC, Libertyville, IL) have been shown to inhibit fruit drop and retain stone fruit and apple fruit quality (Silverman, et al., 2004. Plant Growth Reg. 43:153-161), increase cherry and walnut fruit set (Retamales and Petracek, 2010. Acta Hort. 884:337-341) and increase male flower number in cucurbits. AVG-HCl is marketed under the tradename ReTain® (ReTain is a registered trademark of and available from Valent BioSciences LLC).

1-amino-1-cyclopropanecarboxylic acid (“ACC”) is synthesized by ACC synthase in plants and acts as a precursor for the biosynthesis of ethylene. Ethylene has been shown to be involved in several plant responses including stress, fruit set, leaf abscission and anthesis. Because of its role as an ethylene precursor ACC has been used in agriculture to induce ethylene responsive events.

Apple qualities are highly important to marketability. Consumers and retailers require particular traits when selecting apples to buy and sell. These traits include color, size, texture, and firmness. However, many growers struggle to grow apples that satisfy these requirements. Of particular value is apple coloration which is associated with increased nutritional value. Retailers require around 50-60% coloration, which can be difficult to obtain. Thus, there is a need in the art for compositions capable of achieving enhanced apple traits including coloration.

### SUMMARY OF THE INVENTION

In one aspect, the present invention is directed to an agricultural mixture comprising an agricultural mixture comprising aminoethoxyvinylglycine or a salt thereof and 1-amino-1-cyclopropanecarboxylic acid, a hydrate thereof, a polymorph thereof or a salt thereof.

In another aspect, the present invention is further directed to methods of enhancing apple characteristics including, but not limited to, color, size, texture and firmness comprising applying an effective amount of aminoethoxyvinylglycine or a salt thereof and an effective amount of 1-amino-1-cyclopropanecarboxylic acid, a hydrate thereof, a polymorph thereof or a salt thereof to apples.

In another aspect, the present invention is further directed to methods of reducing fruit drop in an apple tree comprising applying an effective amount of aminoethoxyvinylglycine or a salt thereof and an effective amount of 1-amino-1-cyclopropanecarboxylic acid, a hydrate thereof, a polymorph thereof or a salt thereof to the apple tree.

### DETAILED DESCRIPTION OF THE INVENTION

Applicant has discovered that a mixture of aminoethoxyvinylglycine (“AVG”) and 1-amino-1-cyclopropanecarboxylic acid (“ACC”) is unexpectedly superior at enhancing apple characteristics as compared to application of either alone. Applicant has particularly discovered that a mixture of AVG and ACC is unexpectedly superior at enhancing apple coloration as compared to application of either alone.

In one embodiment, the present invention is directed to an agricultural mixture comprising AVG or a salt thereof and ACC, a hydrate thereof, a polymorph thereof or a salt thereof.

AVG and ACC can be used in the form of salt derived from inorganic or organic acids or bases. Acid addition salts of the active ingredients of the present invention can be prepared in situ during the final isolation and purification of the compounds of the invention or separately by reacting a free base function with a suitable organic acid. Representative acid addition salts include, but are not limited to acetate, adipate, alginate, aspartate, benzoate, benzenesulfonate, bisulfate, butyrate, camphorate, camphorsulfonate, digluconate, glycerophosphate, hemisulfate, heptanoate, hexanoate, fumarate, hydrochloride, hydrobromide, hydroiodide, 2-hydroxyethansulfonate (isothionate), lactate, maleate, methanesulfonate, nicotinate, 2-naphthalenesulfonate, oxalate, palmitoate, pectinate, persulfate, 3-phenylpropionate, picrate, pivalate, propionate, succinate, tartrate, thiocyanate, phosphate, glutamate, bicarbonate, p-toluenesulfonate and undecanoate. Also, the basic nitrogen-containing groups can be quaternized with such agents as lower alkyl halides such as methyl, ethyl, propyl, and butyl chlorides, bromides and iodides; dialkyl sulfates like dimethyl, diethyl, dibutyl and diamyl sulfates; long chain halides such as decyl, lauryl, myristyl and stearyl chlorides, bromides and iodides; arylalkyl halides like benzyl and phenethyl bromides and others. Water or oil-soluble or dispersible products are thereby obtained. Examples of acids which can be employed to form acid addition salts include such inorganic acids as hydrochloric acid, hydrobromic acid, hyaluronic acid, and phosphoric acid and such organic acids as oxalic acid, maleic acid, methanosulfonic acid, and succinic acid. Basic addition salts can be prepared in situ during the final isolation and purification of compounds of this invention by reacting a carboxylic acid-containing moiety with a suitable base such as the hydroxide, carbonate or bicarbonate of a pharmaceutically acceptable metal cation or with ammonia or an organic primary, secondary or tertiary amine. Salts include, but are not limited to, cations based on alkali metals or alkaline earth metals such as lithium, sodium, potassium, calcium, magnesium and aluminum salts and the like and nontoxic quaternary ammonia and amine cations including ammonium, tetramethylammonium, tetraethylammonium, methylammonium, dimethylammonium, trimethylammonium, triethylammonium, diethylammonium, and ethylammonium among others. Other representative organic amines useful for the formation of base addition salts include ethylenediamine, ethanolamine, diethanolamine, piperidine, piperazine and the like.

Hydrates of ACC suitable for use in the present invention include, but are not limited to, ACC hemihydrate, trihydrate and ACC anhydrate.

In a preferred embodiment, the concentration ratio AVG or salt thereof to ACC, a hydrate thereof, a polymorph thereof or a salt thereof is from about 1,000:1 to about 1:1,000, from about 900:1 to about 1:900, from about 800:1 to about 1:800, from about 700:1 to about 1:700, from about 600:1 to about 1:600, from about 500:1 to about 1:500, from about 400:1 to about 1:400, from about 300:1 to about 1:300, from about 200:1 to about 1:200, from about 100:1 to about 1:100, from about 90:1 to about 1:90, from about 80:1 to about 1:80, from about 70:1 to about 1:70, from about 60:1 to about 1:60, from about 50:1 to about 1:50, from about 40:1 to about 1:40, from about 30:1 to about 1:30, from about 20:1 to about 1:20, from about 10:1 to about 1:10, from about 9:1 to about 1:9, from about 8:1 to about 1:8, from about 7:1 to about 1:7, from about 6:1 to about 1:6, from about 5:1 to about 1:5, from about 4:1 to about 1:4, from about 3:1 to about 1:3, from about 2:1 to about 1:2 and about 1:1.

In a preferred embodiment, AVG or a salt thereof is present in compositions of the present invention at a concentration or may be applied at a concentration from about 1 to about 1,000 parts per million (“ppm”), more preferably at a concentration from about 1 to about 900 ppm, from about 1 to about 800 ppm, from about 1 to about 700 ppm, from about 1 to about 600 ppm, from about 1 to about 500 ppm, from about 1 to about 400 ppm, from about 1 to about 300 ppm, from about 1 to about 200 ppm or from about 1 to about 100 ppm.

In another preferred embodiment, AVG or a salt thereof is present in compositions of the present invention at a concentration or may be applied at a concentration from about 10 to about 1,000 ppm, more preferably at a concentration from about 10 to about 900 ppm, from about 10 to about 800 ppm, from about 10 to about 700 ppm, from about 10 to about 600 ppm, from about 10 to about 500 ppm, from about 10 to about 400 ppm, from about 10 to about 300 ppm, from about 10 to about 200 ppm or from about 10 to about 100 ppm.

In another preferred embodiment, AVG or a salt thereof is present in compositions of the present invention at a concentration or may be applied at a concentration from about 100 to about 1,000 ppm, more preferably at a concentration from about 100 to about 900 ppm, from about 100 to about 800 ppm, from about 100 to about 700 ppm, from about 100 to about 600 ppm, from about 100 to about 500 ppm, from about 100 to about 400 ppm, from about 100 to about 300 ppm, or from about 100 to about 200 ppm.

In another preferred embodiment, AVG or a salt thereof is present in compositions of the present invention at a concentration or may be applied at a concentration from about 200 to about 1,000 ppm, more preferably at a concentration from about 200 to about 900 ppm, from about 200 to about 800 ppm, from about 200 to about 700 ppm, from about 200 to about 600 ppm, from about 200 to about 500 ppm, from about 200 to about 400 ppm and from about 200 to about 300 ppm.

In a preferred embodiment, ACC, a hydrate thereof, a polymorph thereof or a salt thereof is present in compositions of the present invention at a concentration or may be applied at a concentration from about 1 to about 1,000 parts ppm, more preferably at a concentration from about 1 to about 900 ppm, from about 1 to about 800 ppm, from about 1 to about 700 ppm, from about 1 to about 600 ppm, from about 1 to about 500 ppm, from about 1 to about 400 ppm, from about 1 to about 300 ppm, from about 1 to about 200 ppm or from about 1 to about 100 ppm.

In another preferred embodiment, ACC, a hydrate thereof, a polymorph thereof or a salt thereof is present in compositions of the present invention at a concentration or may be applied at a concentration from about 10 to about 1,000 ppm, more preferably at a concentration from about 10 to about 900 ppm, from about 10 to about 800 ppm, from about 10 to about 700 ppm, from about 10 to about 600 ppm, from about 10 to about 500 ppm, from about 10 to about 400 ppm, from about 10 to about 300 ppm, from about 10 to about 200 ppm or from about 10 to about 100 ppm.

In another preferred embodiment, ACC, a hydrate thereof, a polymorph thereof or a salt thereof is present in compositions of the present invention at a concentration or may be applied at a concentration from about 100 to about 1,000 ppm, more preferably at a concentration from about 100 to about 900 ppm, from about 100 to about 800 ppm, from about 100 to about 700 ppm, from about 100 to about 600 ppm, from about 100 to about 500 ppm, from about 100 to about 400 ppm, from about 100 to about 300 ppm, or from about 100 to about 200 ppm.

In another preferred embodiment, ACC, a hydrate thereof, a polymorph thereof or a salt thereof is present in compositions of the present invention at a concentration or may be applied at a concentration from about 200 to about 1,000 ppm, more preferably at a concentration from about 200 to about 900 ppm, from about 200 to about 800 ppm, from about 200 to about 700 ppm, from about 200 to about 600 ppm, from about 200 to about 500 ppm, from about 200 to about 400 ppm and from about 200 to about 300 ppm.

In a preferred embodiment, the compositions of the present invention may further comprise one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

In another embodiment, the present invention is directed to methods of enhancing apple characteristics comprising applying an effective amount of AVG or a salt thereof and ACC a hydrate thereof, a polymorph thereof or a salt thereof to apples.

In a preferred embodiment, apple characteristics that may be enhanced by methods of the present invention are selected from the group consisting of color including percent coverage and intensity, anthocyanin content including percent coverage and intensity, fruit firmness, background or ground color, soluble solids content, fruit greasiness, starch pattern index, internal ethylene concentration, watercore incidence and severity, soggy breakdown, internal browning, superficial scald, watercore breakdown and lenticel breakdown.

In another embodiment, the present invention is directed to methods of reducing fruit drop in an apple tree comprising applying an effective amount of AVG or a salt thereof and an effective amount of ACC, a hydrate thereof, a polymorph thereof or a salt thereof to the apple tree.

In a preferred embodiment, the present invention is directed to methods of enhancing apple coloration comprising applying an effective amount of AVG or a salt thereof and an effective amount of ACC, a hydrate thereof, a polymorph thereof or a salt thereof to the apple tree.

In a preferred embodiment, AVG or a salt thereof and ACC, a hydrate thereof, a polymorph thereof or a salt thereof may be applied simultaneously or sequentially. In a more preferred embodiment, application of an effective amount of AVG or a salt thereof and an effective amount of ACC, a hydrate thereof, a polymorph thereof or a salt thereof may each occur one or more times. When application of either AVG or a salt thereof and/or ACC, a hydrate thereof, a polymorph thereof occurs more than once the order of the applications is not limited. For example, if AVG or a salt thereof is applied first, the next application may be AVG or salt thereof or ACC, a hydrate thereof, a polymorph thereof or a salt thereof and vice versa. Further, when more than one application occurs each application may independently comprise application of AVG or a salt thereof, ACC, a hydrate thereof, a polymorph thereof or a salt thereof or simultaneous application of AVG or a salt thereof and ACC, a hydrate thereof, a polymorph thereof or a salt thereof.

In another preferred embodiment, AVG or a salt thereof and ACC, a hydrate thereof, a polymorph thereof or a salt thereof may be applied prior to harvest, during harvest or after harvest.

In a preferred embodiment, AVG or a salt thereof may be applied at a rate from about 1 to about 1,000 grams per hectare (“g/HA”), more preferably at a concentration from about 1 to about 900 ppm, from about 1 to about 800 g/HA, from about 1 to about 700 g/HA, from about 1 to about 600 g/HA, from about 1 to about 500 g/HA, from about 1 to about 400 g/HA, from about 1 to about 300 g/HA, from about 1 to about 200 g/HA or from about 1 to about 100 g/HA.

In another preferred embodiment, AVG or a salt thereof may be applied at a rate from about 10 to about 1,000 g/HA, more preferably at a concentration from about 10 to about 900 g/HA, from about 10 to about 800 g/HA, from about 10 to about 700 g/HA, from about 10 to about 600 g/HA, from about 10 to about 500 g/HA, from about 10 to about 400 g/HA, from about 10 to about 300 g/HA, from about 10 to about 200 g/HA or from about 10 to about 100 g/HA.

In another preferred embodiment, AVG or a salt thereof may be applied at a rate from about 100 to about 1,000 g/HA, more preferably at a concentration from about 100 to about 900 g/HA, from about 100 to about 800 g/HA, from about 100 to about 700 g/HA, from about 100 to about 600 g/HA, from about 100 to about 500 g/HA, from about 100 to about 400 g/HA, from about 100 to about 300 g/HA, or from about 100 to about 200 g/HA.

In another preferred embodiment, AVG or a salt thereof may be applied at a rate from about 200 to about 1,000 g/HA, more preferably at a concentration from about 200 to about 900 g/HA, from about 200 to about 800 g/HA, from about 200 to about 700 g/HA, from about 200 to about 600 g/HA, from about 200 to about 500 g/HA, from about 200 to about 400 g/HA and from about 200 to about 300 g/HA.

In a preferred embodiment, ACC, a hydrate thereof, a polymorph thereof or a salt thereof may be applied at a rate from about 1 to about 1,000 g/HA, more preferably at a concentration from about 1 to about 900 g/HA, from about 1 to about 800 g/HA, from about 1 to about 700 g/HA, from about 1 to about 600 g/HA, from about 1 to about 500 g/HA, from about 1 to about 400 g/HA, from about 1 to about 300 g/HA, from about 1 to about 200 g/HA or from about 1 to about 100 g/HA.

In another preferred embodiment, ACC, a hydrate thereof, a polymorph thereof or a salt thereof may be applied at a rate from about 10 to about 1,000 g/HA, more preferably at a concentration from about 10 to about 900 g/HA, from about 10 to about 800 g/HA, from about 10 to about 700 g/HA, from about 10 to about 600 g/HA, from about 10 to about 500 g/HA, from about 10 to about 400 g/HA, from about 10 to about 300 g/HA, from about 10 to about 200 g/HA or from about 10 to about 100 g/HA.

In another preferred embodiment, ACC, a hydrate thereof, a polymorph thereof or a salt thereof may be applied at a rate from about 100 to about 1,000 g/HA, more preferably at a concentration from about 100 to about 900 g/HA, from about 100 to about 800 g/HA, from about 100 to about 700 g/HA, from about 100 to about 600 g/HA, from about 100 to about 500 g/HA, from about 100 to about 400 g/HA, from about 100 to about 300 g/HA, or from about 100 to about 200 g/HA.

In another preferred embodiment, ACC, a hydrate thereof, a polymorph thereof or a salt thereof may be applied at a rate from about 200 to about 1,000 g/HA, more preferably at a concentration from about 200 to about 900 g/HA, from about 200 to about 800 g/HA, from about 200 to about 700 g/HA, from about 200 to about 600 g/HA, from about 200 to about 500 g/HA, from about 200 to about 400 g/HA and from about 200 to about 300 g/HA.

The mixtures of the present invention can be applied by any convenient means. Those skilled in the art are familiar with the modes of application that include foliar applications such as spraying, dusting, and granular applications; soil applications including spraying, in-furrow treatments, or side-dressing. In a preferred embodiment, the mixtures of the present invention are applied to the plant and/or its fruit as a spray and even more preferably as a foliar spray or space spray.

Throughout the application, all disclosed numerical ranges include all possible points (e.g., integers and decimals) within those ranges. All possible points within the ranges disclosed in the application can also be used as endpoints for ranges between these points. For example, a range of 0.01 to 99.99% includes 0.02% . . . 0.021% . . . 0.03% . . . 1% . . . 99.98% etc. and all ranges made up of these integers and decimals.

As used herein, all numerical values relating to amounts, weight percentages and the like are defined as “about” or “approximately” each particular value, namely, plus or minus 10%. For example, the phrase “about 5,000 parts per million” is to be understood as “from 4,500 to 5,500 parts per million.” Therefore, amounts within 10% of the claimed values are encompassed by the scope of the claims.

As used herein “enhance” or “enhancing” refers to providing the apple or apple tree with a beneficial modification of the characteristic. For example, enhancement of apple coloration refers to increasing the red color as either a percent coverage of the color of the total apple and/or intensity level of the red color. As a further example, enhancement of apple greasiness refers to reducing the amount of greasiness of the apple. It is well known in the art and a skilled artisan understands whether an increase or decrease in any particular apple characteristic is beneficial to the grower.

As used herein, the term “fruit drop” refers to plant parts including fruit that naturally abscise from the plant.

As used herein, the term “naturally abscise” refers to the natural detachment of a plant part including fruit via physiological means.

As used herein, “reducing fruit drop” means that the number of the plant parts including fruit on one plant or the average number of plant parts including fruit per plant that naturally abscise from the plant has been reduced as compared to the number of plant parts or average plant parts per plant prior to application of AVG or salt thereof and ACC a hydrate thereof, a polymorph thereof or a salt thereof as compared to the percentage of plants parts naturally abscised from a similar plant or the average number of plant parts naturally abscised from a similar plant in a similar environment that has not received application of AVG or salt thereof and ACC a hydrate thereof, a polymorph thereof or a salt thereof.

As used herein, “composition” refers to one or more active ingredients in a carrier. The carrier may be a liquid, a semi-solid, a solid or a gas and may contain additional ingredients. For example, a fermentation broth is a suitable carrier for the present invention.

The term “effective amount” means the amount of the formulation that will control the target pest. The “effective amount” will vary depending on the mixture concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

Throughout the application, the singular forms “a,” “an,” and “the” include plural reference unless the context clearly dictates otherwise.

The invention is demonstrated by the following representative examples. These examples are offered by way of illustration only and not by way of limitation.

### EXAMPLES

### Example 1—Apple Characteristics in Cripps Pink Variety

### Method

10 sets of unripened apples, Cripps Pink variety, harvested three weeks before the normal harvest date, were each foliar sprayed with either 1) 0.05% Regulaid® as a control, 2) 125 ppm ACC, 3) 250 ppm ACC, 4) 500 ppm ACC, 5) 125 ppm AVG, 6) 125 ppm ACC and 125 ppm AVG, 7) 250 ppm ACC and 125 ppm AVG or 8) 500 ppm ACC and 125 ppm AVG. 34 hours post spray application percent red pixel area (shaded), ground color, fruit firmness, starch conversion and brix were measured. Results can be found in Table 1, below.

TABLE 1

| | Average % | | | | | | | | | |
|---|---|---|---|---|---|---|---|---|---|---|
| | Red Pixel | | Ground | | | | | | | |
| Treatment | Area | | Color | | Firmness | | Starch | | Brix | |
| 0.05% | 5.2 | e* | 2.89 | f | 8.74 | a | 33.5 | e | 12.23 | a |
| Regulaid ® | | | | | | | | | | |
| (Control) | | | | | | | | | | |
| 125 ppm ACC | 6.9 | cd | 3.01 | cde | 8.61 | ab | 40 | cd | 12.25 | a |
| 250 ppm ACC | 8 | ab | 2.96 | def | 8.58 | abc | 45.3 | bc | 12.5 | a |
| 500 ppm ACC | 8.7 | a | 3.04 | cd | 8.4 | c | 56.2 | a | 12.51 | a |
| 125 ppm AVG | 6.3 | d | 2.93 | ef | 8.62 | ab | 25.9 | f | 12.33 | a |
| 125 ppm ACC | 7.4 | bc | 3.08 | bc | 8.62 | ab | 37.6 | de | 12.45 | a |
| 125 ppm AVG | | | | | | | | | | |
| 250 ppm ACC | 7.5 | bc | 3.14 | ab | 8.42 | c | 42 | cd | 12.62 | ab |
| 125 ppm AVG | | | | | | | | | | |
| 500 ppm ACC | 8.6 | a | 3.18 | a | 8.49 | bc | 49.2 | b | 13.04 | b |

125 ppm AVG

*Data points not sharing the same letter indicate a statistically significant difference between the two data points.

### Example 2—Apple Coloration in Cripps Pink Variety

### Method

10 sets of unripened apples, Cripps Pink variety, harvested three weeks before the normal harvest date, were each foliar sprayed with either 1) 0.05% Regulaid® as a control, 2) 125 ppm ACC, 3) 250 ppm ACC, 4) 500 ppm ACC, 5) 125 ppm AVG, 6) 125 ppm ACC and 125 ppm AVG, 7) 250 ppm ACC and 125 ppm AVG or 8) 500 ppm ACC and 125 ppm AVG. 34 hours post spray application percent red pixel area (shaded) was measured. Results can be found in Table 2, below. Pink Lady denotes apples with a blush of greater than 40%, Cripps Red denotes apples with a blush from 20% to 40% and Class 3 denotes apples with a blush of less than 20%.

TABLE 2

| | | | |
|---|---|---|---|
| | % | % | |
| | Pink | Cripps | % |
| Treatment | Lady | Red | Class 3 |

| | | | | | | |
|---|---|---|---|---|---|---|
| 0.05% | 58 | e* | 22.5 | a | 19.5 | a |

Regulaid ®
(Control)

| | | | | | | |
|---|---|---|---|---|---|---|
| 125 ppm ACC | 76.5 | cd | 15 | ab | 8.5 | b |
| 250 ppm ACC | 84.5 | abc | 11.5 | bc | 4 | b |
| 500 ppm ACC | 89 | ab | 9 | bc | 2 | b |
| 125 ppm AVG | 69.5 | d | 21.5 | a | 9 | b |
| 125 ppm ACC | 76.5 | bcd | 15.5 | ab | 5 | b |

125 ppm AVG

| | | | | | | |
|---|---|---|---|---|---|---|
| 250 ppm ACC | 85 | abc | 8 | bc | 7 | b |

125 ppm AVG

| | | | | | | |
|---|---|---|---|---|---|---|
| 500 ppm ACC | 91 | a | 4.5 | c | 4.5 | b |

125 ppm AVG

*Data points not sharing the same letter indicate a statistically significant difference between the two data points.

### Example 3—Fruit Drop in Cripps Pink Variety

### Method

AVG and/or ACC were applied to apple trees with mature apples of the Cripps Pink variety, wherein each set of trees were foliar sprayed with either 1) 0.05% Regulaid® as a control, 2) 125 ppm ACC, 3) 250 ppm ACC, 4) 500 ppm ACC, 5) 125 ppm AVG, 6) 125 ppm ACC and 125 ppm AVG, 7) 250 ppm ACC and 125 ppm AVG or 8) 500 ppm ACC and 125 ppm AVG. Results can be found in Table 3, below.

TABLE 3

| | # of Fruit | # of Fruit | |
|---|---|---|---|
| | Dropped | Dropped | Total # of |
| | (Evaluation | (Evaluation | Fruit |
| Treatment | 1) | 2) | Dropped |
| 0.05% | 14.0 c* | 4.8 c | 22.9 c |
| Regulaid ® | | | |
| (Control) | | | |
| 125 ppm ACC | 11.3 c | 10.4 bc | 26.3 c |
| 250 ppm ACC | 15.2 c | 16.4 b | 35.2 bc |
| 500 ppm ACC | 59.7 a | 40.1 a | 105.8 a |
| 125 ppm AVG | 9.7 c | 7.4 c | 20.8 c |
| 125 ppm ACC | 9.9 c | 6.1 c | 19.4 c |
| 125 ppm AVG | | | |
| 250 ppm ACC | 11.9 c | 8.0 bc | 22.9 c |
| 125 ppm AVG | | | |
| 500 ppm ACC | 32.9 b | 11.1 bc | 47.8 b |
| 125 ppm AVG | | | |

*Data points not sharing the same letter indicate a statistically significant difference between the two data points.

### Example 4—Apple Greasiness in Cripps Pink Variety

### Method

10 sets of unripened apples, Cripps Pink variety, harvested three weeks before the normal harvest date, were each foliar sprayed with either 1) 0.05% Regulaid® as a control, 2) 125 ppm ACC, 3) 250 ppm ACC, 4) 500 ppm ACC, 5) 125 ppm AVG, 6) 125 ppm ACC and 125 ppm AVG, 7) 250 ppm ACC and 125 ppm AVG or 8) 500 ppm ACC and 125 ppm AVG. Following 12 weeks of cold storage and 7 days at room temperature greasiness was measured. Results can be found in Tables 4 (harvest 1) and 5 (harvest 2), below.

TABLE 4

| | Percent | | Percent | | Percent | | Percent | |
|---|---|---|---|---|---|---|---|---|
| | Fruit | | Fruit with | | Fruit with | | Fruit with | |
| | with No | | Slight | | Moderate | | Severe | |
| Treatment | Greasiness | | Greasiness | | Greasiness | | Greasiness | |
| 0.05% | 68 | b* | 8 | bc | 19 | a | 5 | cd |
| Regulaid ® | | | | | | | | |
| (Control) | | | | | | | | |
| 125 ppm ACC | 21 | c | 22 | a | 40 | b | 17 | bcd |
| 250 ppm ACC | 5 | d | 16 | ab | 40 | b | 39 | a |
| 500 ppm ACC | 1 | d | 7 | bc | 44 | b | 48 | a |
| 125 ppm AVG | 94 | a | 5 | bc | 1 | a | 0 | d |
| 125 ppm ACC | 21 | c | 21 | a | 51 | b | 7 | cd |
| 125 ppm AVG | | | | | | | | |
| 250 ppm ACC | 8 | cd | 22 | a | 49 | b | 21 | bc |
| 125 ppm AVG | | | | | | | | |
| 500 ppm ACC | 5 | d | 2 | c | 59 | b | 34 | ab |

125 ppm AVG

*Data points not sharing the same letter indicate a statistically significant difference between the two data points.

TABLE 5

| | Percent | | Percent | | Percent | | Percent | |
|---|---|---|---|---|---|---|---|---|
| | Fruit | | Fruit with | | Fruit with | | Fruit with | |
| | with No | | Slight | | Moderate | | Severe | |
| Treatment | Greasiness | | Greasiness | | Greasiness | | Greasiness | |
| 0.05% | 9 | a | 7 | b | 66 | a | 18 | cd |
| Regulaid ® | | | | | | | | |
| (Control) | | | | | | | | |
| 125 ppm ACC | 0 | a | 0 | c | 31.1 | bc | 68.9 | b |
| 250 ppm ACC | 0 | a | 0 | c | 15 | cd | 85 | ab |
| 500 ppm ACC | 0 | a | 0 | c | 19 | cd | 81 | ab |
| 125 ppm AVG | 22 | b | 27 | a | 49 | ab | 2 | d |
| 125 ppm ACC | 0 | a | 0 | c | 64 | a | 36 | d |
| 125 ppm AVG | | | | | | | | |
| 250 ppm ACC | 0 | a | 0 | c | 21 | cd | 79 | ab |
| 125 ppm AVG | | | | | | | | |
| 500 ppm ACC | 0 | a | 0 | c | 6 | d | 94 | a |

125 ppm AVG

*Data points not sharing the same letter indicate a statistically significant difference between the two data points.

What is claimed is:

1. An agricultural mixture comprising aminoethoxyvinylglycine or a salt thereof and 1-amino-1-cyclopropanecarboxylic acid, a hydrate thereof, a polymorph thereof or a salt thereof.

2. The mixture of claim 1, wherein aminoethoxyvinylglycine or a salt thereof and 1-amino-1-cyclopropanecarboxylic acid, a hydrate thereof, a polymorph thereof or a salt thereof are present at a concentration ratio from about 1,000:1 to about 1:1,000.

3. A composition comprising a mixture of claim 1.

4. The composition of claim 3, wherein the concentration of aminoethoxyvinylglycine or a salt thereof is from about 1 to about 1,000 ppm.

5. The composition of claim 3, wherein the concentration of 1-amino-1-cyclopropanecarboxylic acid, a hydrate thereof, a polymorph thereof or a salt thereof is from about 1 to about 1,000 ppm.

6. The composition of claim 3, wherein the composition further comprises one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

7. A method of enhancing apple characteristics comprising applying an effective amount of a mixture of aminoethoxyvinylglycine or a salt thereof and 1-amino-1-cyclopropanecarboxylic acid, a hydrate thereof, a polymorph thereof or a salt thereof to apples.

8. The method of claim 7, wherein apples characteristics are selected from the group consisting of color coverage, color intensity, anthocyanin content coverage, anthocyanin intensity, fruit firmness, background color, soluble solids content, fruit greasiness, starch pattern index, internal ethylene concentration, watercore incidence, watercore breakdown, watercore severity, soggy breakdown, internal browning, superficial scald, and lenticel breakdown.

9. The method of claim 7, wherein aminoethoxyvinylglycine or a salt thereof is applied at a rate from about 1 to about 1,000 grams per hectare.

10. The method of claim 7, wherein 1-amino-1-cyclopropanecarboxylic acid, a hydrate thereof, a polymorph thereof or a salt thereof is applied at a rate from about 1 to about 1,000 grams per hectare.

11. A method of enhancing apple coloration comprising applying an effective amount of a mixture of aminoethoxyvinylglycine or a salt thereof and 1-amino-1-cyclopropanecarboxylic acid, a hydrate thereof, a polymorph thereof or a salt thereof to apples.

12. The method of claim 11, wherein aminoethoxyvinylglycine or a salt thereof is applied at a rate from about 1 to about 1,000 grams per hectare.

13. The method of claim 11, wherein 1-amino-1-cyclopropanecarboxylic acid, a hydrate thereof, a polymorph thereof or a salt thereof is applied at a rate from about 1 to about 1,000 grams per hectare.

14. A method of reducing fruit drop in an apple tree comprising applying an effective amount of AVG or a salt thereof and an effective amount of ACC, a hydrate thereof, a polymorph thereof or a salt thereof to the apple tree.

15. The method of claim 14, wherein aminoethoxyvinylglycine or a salt thereof is applied at a rate from about 1 to about 1,000 grams per hectare.

16. The method of claim 14, wherein 1-amino-1-cyclopropanecarboxylic acid, a hydrate thereof, a polymorph thereof or a salt thereof is applied at a rate from about 1 to about 1,000 grams per hectare.
